(19) United States
(12) Patent Application Publication
(10) Pub. No.: US 2010/0167728 A1
(43) Pub. Date: Jul. 1, 2010

(54) APPARATUS AND METHOD FOR FEMTO CELL COVERAGE MAPPING USING MACRO BASE STATION

(75) Inventors: Narayanan VENKITARAMAN, Palatine, IL (US); Sandeep ADWANKAR, Buffalo Grove, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/347,431

(22) Filed: Dec. 31, 2008

(51) Int. Cl. H04W 76/00; H04W 36/00

(52) U.S. Cl. 455/434; 455/444; 455/456.1

(57) ABSTRACT

A method and apparatus are disclosed for selecting between connection of a mobile communication device to a macro cell or connection of the mobile communication device to one of a plurality of femto cells in a network. The method includes determining a mapping of locations of the femto cells within coverage range of the macro cell, determining whether network considerations indicate the mobile communications device should be connected to the macro cell or to one of the plurality of femto cells, and enabling connection of the mobile communications device to the macro cell or to one of the plurality of femto cells based on the network considerations and the mapping of locations of the femto cells.

### BACKGROUND OF THE INVENTION

1. Field of the Invention

The invention relates to an apparatus and method for femto cell coverage mapping.

2. Introduction

Mobile communications devices, such as cellular phones, are becoming very pervasive. Cellular systems have typically used a radio access network covering geographic areas, with each geographic area divided into cell areas, with each cell area being served by a base station. The cell areas are also know as macro cells. Cellular coverage is provided by radio base station equipment at a base station site. Typically, the base stations may be connected to a radio network controller, also known as a base station controller, which supervises and coordinates activities of the base stations connected thereto. A plurality of radio network controllers may be connected to a one or more core networks.

A user of a cellular phone may be moving, such as when travelling by car or the like, and may move from an area where coverage may be provided by one macro cell, into an area where coverage is provided by another macro cell. The signal may be handed off from one macro cell to another as the user moves between the coverage areas.

Modern third generation (3G) systems provide voice and data communications provide wide area coverage with numerous base stations and a centralized radio network controller. Signals from the 3G networks operate at very high frequencies and high bandwidths and have a difficult time penetrating through structures. These networks were not designed to provide effective coverage for individual indoor and/or residential situations, with location of cell sites becoming increasingly problematic.

In recent years, the femto cell has been developed to provide high performance coverage in the home or indoor environment. A femto cell is a low capacity base station, and is connected to the operators mobile network over existing broadband connection in the home or indoor environment.

In a network having a large number of such femto cells, the femto cells may be used by the network when coverage from a macro cell is not sufficient, or when it would be more efficient to hand off a call to a femto cell. However, it is difficult to determine a location of a large number of femto cells in relation to each macro cell to enable efficient handoff.

### SUMMARY OF THE INVENTION

A method and apparatus are disclosed for selecting between connection of a mobile communication device to a macro cell or connection of the mobile communication device to one of a plurality of femto cells in a network. The method includes determining a mapping of locations of the femto cells within coverage range of the macro cell, determining whether network considerations indicate the mobile communications device should be connected to the macro cell or to one of the plurality of femto cells, and enabling connection of the mobile communications device to the macro cell or to one of the plurality of femto cells based on the network considerations and the mapping of locations of the femto cells.

### BRIEF DESCRIPTION OF THE DRAWINGS

In order to describe the manner in which advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exemplary diagram of a mobile communications device in accordance with embodiments of the invention;

FIG. 2 is a block diagram of an exemplary mobile communications device in accordance with embodiments of the invention;

FIG. 3 is an exemplary block diagram of a mobile communications device and connected elements in a network in accordance with embodiments of the invention;

FIG. 4 is an exemplary block diagram of components of network elements in accordance with embodiments of the invention; and

FIG. 5 is an exemplary flowchart illustrating a method in accordance with embodiments of the invention.

### DETAILED DESCRIPTION OF THE INVENTION

Additional features and advantages of the invention will be set forth in the description which follows and in part will be obvious from the description or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without departing from the spirit and scope of the invention.

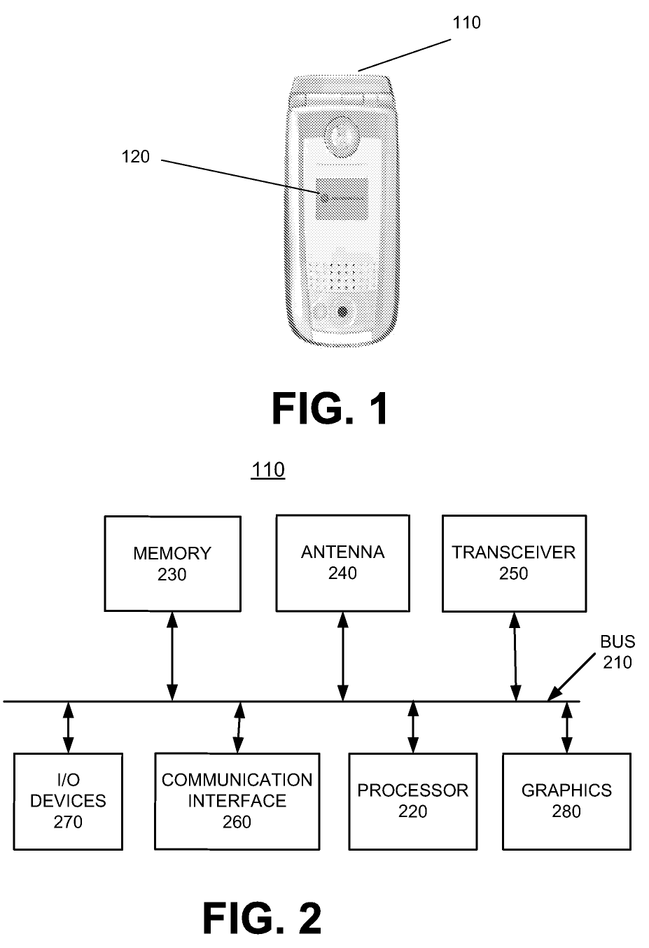

FIG. 1 is an exemplary diagram of a mobile communications device 110 in accordance with a possible embodiment of the invention. The mobile communications device 110 may be any mobile or portable computing device, including a mobile telephone, cellular telephone, a wireless radio, a portable computer, a laptop, satellite radio, satellite television, etc. The mobile communications device 110 may have a display 120, which may be an LCD display, for example. The display may be a touch screen display allowing the user to access various control functions through a user interface, for example. Alternatively, the mobile communications device 110 may have other input/output devices, such as a keyboard, voice-control device, scrolling devices, etc.

FIG. 2 is a block diagram of an exemplary mobile communications device 110 in accordance with a possible embodiment of the invention. The exemplary mobile communications device 110 may include a bus 210, a processor 220, and a memory 230. The bus 210 may permit communication among the components of the mobile communications device 110. The mobile communications device 110 may include other optional elements such as an antenna 240, a transceiver 250, a communication interface 260, input/output I/O) devices 270, and a graphics device 280, although these elements may not be necessary to practice the invention.

Processor 220 may include at least one conventional processor or microprocessor that interprets and executes instructions. Memory 230 may be a random access memory (RAM or another type of dynamic storage device that stores information and instructions for execution by processor 220. Memory 230 may also include a read-only memory (ROM which may include a conventional ROM device or another type of static storage device that stores static information and instructions for processor 220. Memory 230 may also include removable SD cards and SIM (Subscriber Information Module) that can store data such as a base station neighbor list, security keys and policy information.

Transceiver 250 may include one or more transmitters and receivers. The transceiver 250 may include sufficient functionality to interface with any network or communication station and may be defined by hardware or software in any manner known to one of skill in the art. The processor 220 is cooperatively operable with the transceiver 250 to support operations within the network.

Input/output devices I/O devices) may include one or more conventional input mechanisms that permit a user to input information to the mobile communication device 110, such as a microphone, touchpad, keypad, keyboard, mouse, pen, stylus, voice recognition device, buttons, etc. Output devices 270 may include one or more conventional mechanisms that output information to the user, including a display, one or more speakers, etc. The display may typically be an LCD display as used on many conventional mobile computing devices.

Additionally, the mobile communications device 110 may include or have associated with it a second display, either LCD or non-LCD type, functioning as an output device 270. This second display may be built into the device in addition to an LCD display, or may be added to the mobile communications device prior to or after purchase of the mobile communications device 110 by the consumer.

The mobile communications device 110 may perform functions in response to processor 220 by executing sequences of instructions or instruction sets contained in a computer-readable medium, such as, for example, memory 230. Such instructions may be read into memory 230 from another computer-readable medium, such as a storage device, or from a separate device via a communication interface. The programming necessary to accomplish the functionality of the invention may be stored in the memory 230 of the mobile communications device 110 at the time of manufacture, or may be loaded into the memory 230 at a later time.

The mobile communications device 110 illustrated in FIGS. 1-2 and the related discussion are intended to provide a brief, general description of a suitable communication and processing environment in which the invention may be implemented. Although not required, the invention will be described, at least in part, in the general context of computer-executable instructions, such as program modules, being executed by the mobile communications device 110, such as a mobile telephone, or a television set-top box, or by another communications device. Generally, program modules include routine programs, objects, components, data structures, etc., that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

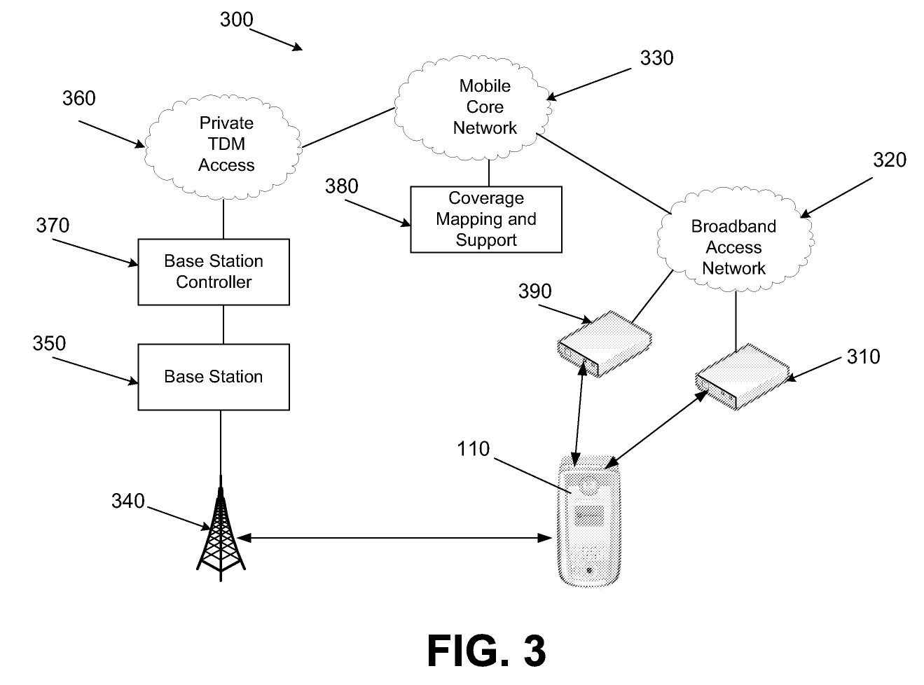

FIG. 3 is an exemplary block diagram of the mobile communications device network 300 in accordance with a possible embodiment of the invention. In this embodiment, the mobile communications device 110 may communicate with one or more wireless networks, such as a GSM or CDMA based cellular network, 3G networks such as UMTS and IP based networks such as WiMAX. The mobile communications device 110 may communicate with one or more macro cells 340, which may include a cell tower or the like for receiving and transmitting signals. Each macro cell 340 has a coverage area, and coverage areas of macro cells may overlap with each other. When the mobile communications device 110 is within the coverage area of a particular macro cell 340, the mobile communications device may transmit and receive signals by wireless to and from the macro cell 340.

Each macro cell is served by a base station 350. In a typical network, a plurality of base stations may be connected to a radio network controller, also called a base station controller 370 (BSC). The base station controller 370 may control a plurality of base stations connected thereto. The base station controller 370 is connected to one or more mobile core network 330 by private TDM access 360, or the like.

The mobile communications device 110 may also be connected to a femto cell 310. The femto cell 310 is a low power base station, typically set up in a home or other indoor environment. The femto cell 310 is typically connected to a broadband access 320, which is typically in a same location as the femto cell 310 in an indoor environment, although it may be a wireless IP connection. The broadband access network 320 connects to the mobile core network 330, and to the base station controller 370. The mobile communications network 300 may also include a plurality of other femto cells 390, typically being used by other users than femto cell 310.

The femto cell 310 typically may be used to provide access to the mobile communications device while the mobile communications device 110 is in the limited range of the femto cell 310. In the presence of a large number of such femto cells 310 within a network, such as with the range of macro cell 340 or a plurality of such macro cells, embodiments of the present invention may enable handoff by determining the location of the femto cells 310, 390 in relation to the macro cell 340, or to one or more macro cells 340, and using that information in combination with network and policy considerations to provision network elements such as the femto cells 310, 390, the macro base station 350, mobile communications device 110, etc., to enable the mobile communications device to use a femto cell or handoff between the femto cell and the macro base station.

Embodiments of the invention may do a mapping of a plurality of femto cells 310 in relation to one or more macro cells 340. The mapping may be controlled a coverage mapping and support functional element 380, which may reside in the base station controller 370 of a corresponding macro cell, for example. The coverage mapping and support functional element 380 performs coverage mapping and provisioning of mobile device, femto BS, macro BS and other elements to enable handoffs. The coverage mapping and support functional element 380 may be a separate element as shown in FIG. 3 or collocated with an existing box such as a mobile base station controller 370, or may be provided by a combination of different boxes.

Mapping of a location of the femto cells will enable the mobile communications network to hand off calls from the macro cell 340 to a femto cell 310, or between two femto cells. This may be desirable when the macro cell 340 becomes congested with calls, or when the mobile communications device 110 is doing data based applications that require extra bandwidth. In some embodiments, when the macro cell 340 is not congested, and the mobile communications device 110 is receiving a voice call, the voice call may be directed through the macro cell to the mobile communications device 110. When the macro cell is congested with calls, then the voice call may be directed to the mobile communications device 110 through a femto cell 310 within range of the mobile communications device 110. The mapping of the location of femto cells may also enable the mobile communication network 300 to determine the power level of some femto cells and thereby enable optimized handoffs. If a cluster of mobile devices may be better served by a femto cell in the area of the mobile device cluster, the mapping and support function may instruct a femto cell to increase the power and instruct the mobile devices in the cluster to move to the newly available connectivity to the femto cell.

In some embodiments, this may be done based on policy settings such that only selected subscribes who may be authorized by the user, operator or both will be able to use the femto cell. For example a user and the operator may authorize friends of the user to also use the femto cell while visiting the user's home. The coverage mapping and support functional element 380 will automatically provision the femto cell and the handset of the user's friend to with the necessary identities and credentials. Also when the friend is under a macro cell that overlaps the femto cell that the friend is authorized to use, coverage mapping and support functional element 380 along with the Base station controller enables the handoff from the macro cell 340 into the femto cell.

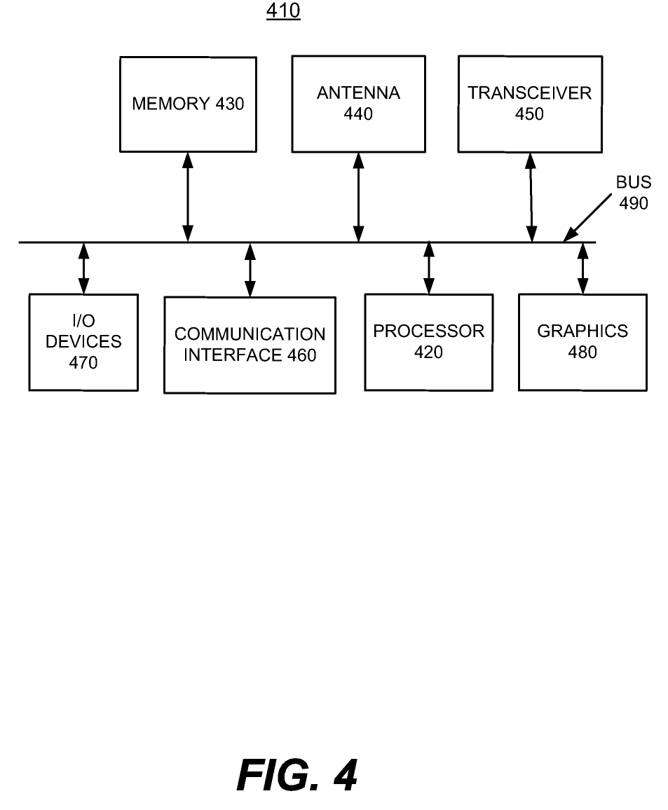

FIG. 4 is a block diagram of components that may be included within any box hosting the coverage mapping and support functional element 380. For example, the box may be one or more of the femto cell 310, the macro cell 340, the base station 350, or the base station controller 370. The components may include a bus 490, a processor 420, and a memory 430. The bus 210 may permit communication among the components of the device. The mobile device may include other optional elements such as an antenna 440, a transceiver 450, a communication interface 460, input/output (I/O) devices 470, and a graphics device 280, although all of these elements may not be necessary to practice the invention.

Embodiments of the invention will determine the coverage mapping of femto cells under macro cells and use that along with policies and network state to determine when to connect the mobile communications device 110 to either the macro cell 340 or one of the femto cells 310. Locations of the femto cells 310 within range of a particular macro cell 340 may be determined by a number of techniques such as signal strength based triangulation, by GPS based triangulation, or by determining a location of a mobile communications device within range of the femto cell 310, and assigning that location to the femto cell. One or a combination of such techniques may be used to build a coverage map indicating the location of femto cell under a macro BS.

When using signal strength based triangulation, a signal is sent to the femto cell 310 from the macro cell 340 and the signal strength is measured and stored. Signal strength from other macro cells is also measured, and using known signal strength triangulation methods, a location of the femto cell can be determined. This may be repeated for various femto cells in the network.

When using GPS based triangulation, a GPS location of the base station 350 is determined, a signal is sent to the femto cell 310 from the macro cell 340 and the signal strength is measured and stored. Signal strength from other macro cells have base stations with known GPS location is also measured, and using known signal strength triangulation methods, a GPS location of the femto cell can be determined. This may be repeated for various femto cells in the network.

In some embodiments, the GPS location may be computed directly by the femto cell 310. Where the GPS location cannot be so determined, when a mobile communications device 110 comes within range of the femto cell 310, the femto cell 310 may obtain a GPS location directly from the mobile communications device 110.

The embodiments of the invention may determine whether to connect the mobile communications device 110 to the macro cell 340 or to the femto cell 310 based on policy and/or network considerations. The policy considerations may include whether the mobile device is authorized to use the femto cell. The network considerations may include traffic congestion of the macro cell 340, the traffic congestion in the broadband network serving the femto cell, and whether the connection is a voice call or a data communication. Such information may be obtained for example by receiving updates from the network elements when the level of congestion exceeds a threshold. When the connection is a data communication, the preference may be to connect to the femto cell due to the increased bandwidth of data communications, and so as to not overload the macro cell 340.

The information about the type of session may be obtained either from the mobile device or from another network element such as for example a Call State Control Function (CSCF) in a IP Multimedia Subsystem (IMS) network. Embodiments of the invention may also determine the operating power of a femto cell. For example, based on the location of one or more mobile devices, the network condition and policies the coverage mapping and support function 380 may instruct one of 2 adjacent femto BS to increase it power and other to switch wireless off to reduce interference and then instruct adjacent mobile devices that can use the femto BS to handoff to the femto BS. Similarly the coverage mapping and support function 380 may also instruct both femto BSs to be on with reduced their power if each BS has only a limited amount of access bandwidth.

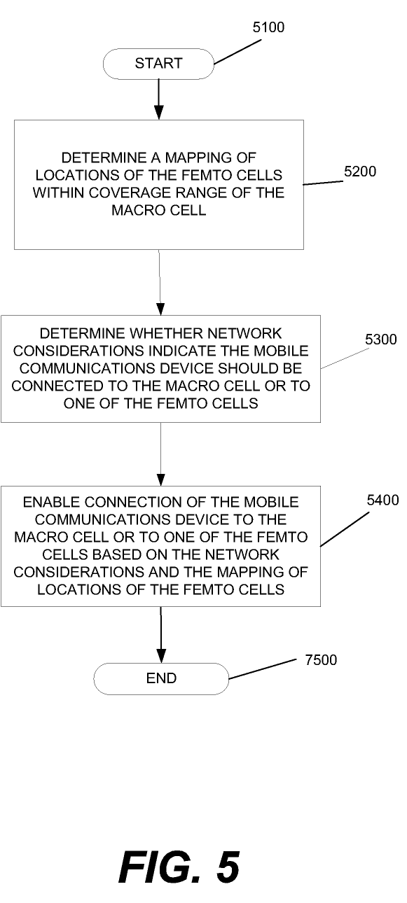

FIG. 5 illustrates a flowchart of a method of selecting between connection of a mobile communication device to a macro cell or connection of the mobile communication device to one of a plurality of femto cells in a network in accordance with embodiments of the invention. At 5100, the method starts.

At 5200, the method determines a mapping of locations of the femto cells 310 within coverage range of the macro cell 340. As discussed earlier this may, for instance, be done using a number of different methods such as using signal strength, GPS triangulation etc. At 5300, the method determines whether network considerations indicate the mobile communications device 110 should be connected to the macro cell 340 or to one of the plurality of femto cells 310. At 5400, the method enables connection of the mobile communications device to the macro cell 340 or to one of the plurality of femto cells 310 based on the network considerations and the mapping of locations of the femto cells. For example, this may be comprise determining that the macro cell 340 is loaded and then determining the location of the mobile communications device 110 with respect to the macro cell 340 using for instance frequency scan reports from the mobile, GPS, triangulation etc, using the location of the mobile communications device 110 and the coverage map of the femto cell with respect to the macro cell 340 to determine that a handoff target exists and then trigger the mobile communications device 110 to handoff. This may also include dynamically provisioning the mobile communications device 110, femto cell and macro cell 340 and the base station controller 370 with information such as identities, power levels and security credentials to enable the handoff. At 5500, the method ends.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. Accordingly, only the appended claims and their legal equivalents should define the invention, rather than any specific examples given.

We claim:

1. A method of selecting between connection of a mobile communication device to a macro cell or connection of the mobile communications device to one of a plurality of femto cells in a network, comprising:
determining a mapping of locations of the femto cells within coverage range of the macro cell;
determining whether network considerations indicate the mobile communications device should be connected to the macro cell or to one of the plurality of femto cells; and
enabling connection of the mobile communications device to the macro cell or to one of the plurality of femto cells based on the network considerations and the mapping of locations of the femto cells.

2. The method of claim 1, further comprising determining a location of the mobile communications device in relation to the mapping of locations of the femto cells.

3. The method of claim 1, wherein the network considerations include whether the macro cell is congested with traffic.

4. The method of claim 1, wherein the network considerations include whether a communication to be directed to the mobile communications device is a voice communication or a data communication.

5. The method of claim 1, wherein determining a mapping of locations of the femto cells within coverage range of the macro cell comprises determining a strength of a signal from the macro cell to each of the femto cells, determining a strength of a signal from at least one other macro cell to each of the femto cells, and using signal strength triangulation to determine a location of each of the femto cells.

6. The method of claim 1, wherein determining a mapping of locations of the femto cells within coverage range of the macro cell comprises determining a GPS location of the femto cells.

7. The method of claim 6, wherein determining a GPS location of the femto cells comprises determining a GPS location of the mobile communications device, determining a femto cell within range of the mobile communications device, and assigning the GPS location of the mobile communications device to the femto cell within range of the mobile communications device.

8. The method of claim 2, further comprising determining that one of the femto cells must be adjusted based on the location of the mobile computing device, the mapping of the location of the femto cells and network considerations, provisioning the femto cell with updated information, and enabling handoff of the mobile device from a macro cell to the femto cell, wherein the provisioning comprises adjusting a power level of the femto cell.

9. A method of operating a network having a base station controller, a macro cell, and a plurality of femto cells, comprising:
determining a mapping of locations of the femto cells within coverage range of the macro cell;
determining a location of a mobile communications device; and
enabling connection of the mobile communications device to the macro cell or to one of the plurality of femto cells based on the mapping of locations of the femto cells and the location of the mobile communications device.

10. The method of claim 9, wherein determining a mapping of locations of the femto cells within coverage range of the macro cell comprises determining a strength of a signal from the macro cell to each of the femto cells, determining a strength of a signal from at least one other macro cell to each of the femto cells, and using signal strength triangulation to determine a location of each of the femto cells.

11. The method of claim 9, wherein determining a mapping of locations of the femto cells within coverage range of the macro cell comprises determining a GPS location of the femto cells.

12. The method of claim 11, wherein determining a GPS location of the femto cells comprises determining a GPS location of the mobile communications device, determining a femto cell within range of the mobile communications device, and assigning the GPS location of the mobile communications device to the femto cell within range of the mobile communications device.

13. The method of claim 10, wherein enabling connection of the mobile communications device to the macro cell or to one of the plurality of femto cells is further based on network considerations.

14. The method of claim 13, wherein the network considerations include whether the macro cell is congested with traffic.

15. The method of claim 13, wherein the network considerations include whether a communication to be directed to the mobile communications device is a voice communication or a data communication.

16. The method of claim 9, further comprising determining that one of the femto cells must be adjusted based on the location of the mobile computing device, the mapping of the location of the femto cells and network considerations, provisioning the femto cell with updated information, and enabling handoff of the mobile device from a macro cell to the femto cell, wherein the provisioning comprises adjusting a power level of the femto cell.

17. A base station controller for connecting a mobile communications device to either of a macro cell or one of a plurality of femto cells, comprising:
a memory that stores a plurality of instructions; and
a processor that executes the instructions to:
determine a mapping of locations of the femto cells within coverage range of the cell;
determine whether network considerations indicate the mobile communications device should be connected to the macro cell or to one of the plurality of femto cells; and
enable connection of the mobile communications device to the macro cell or to one of the plurality of femto cells based on the network considerations and the mapping of locations of the femto cells.

18. The base station controller of claim 17, wherein the network considerations include whether the macro cell is congested with traffic.

19. The base station controller of claim 17, wherein the network considerations include whether a communication to be directed to the mobile communications device is a voice communication or a data communication.

20. The base station controller of claim 19, wherein the processor further determines that one of the femto cells must be adjusted based on the location of the mobile computing device, the mapping of the location of the femto cells and network considerations, provisions the femto cell with updated information, and enables handoff of the mobile device from a macro cell to the femto cell, wherein the provisioning comprises adjusting a power level of the femto cell.
